(19) United States
(12) Patent Application Publication
(10) Pub. No.: US 2024/0230540 A1
(43) Pub. Date: Jul. 11, 2024

(54) WAVEGUIDE SENSOR WINDOW OPENING

(71) Applicant: ams-OSRAM AG, Premstätten (AT)

(72) Inventors: Deborah MORECROFT, Unterpremstätten (AT); Jochen KRAFT, Bruck/Mur (AT); Desiree RIST, Graz (AT); Josef EHGARTNER, Graz (AT)

(21) Appl. No.: 18/560,163

(22) PCT Filed: May 4, 2022
(86) PCT No.: PCT/EP2022/061999

§ 371 Date: Nov. 10, 2023

(30) Foreign Application Priority Data
May 11, 2021 (DE) 10 2021 112 276.7

(51) Int. Cl. G01N 21/77; G02B 6/136; G02B 6/12

(52) U.S. Cl. CPC G01N 21/7703; G02B 6/136; G01N 2021/7779; G01N 2201/0221; G02B 2006/12138

(57) ABSTRACT

A method for manufacturing a sensor includes providing a lower cladding layer, depositing a waveguide layer on the lower cladding layer, forming a sensing waveguide and a reference waveguide by photolithography and etching the waveguide layer in places, and forming a photoresist structure-on a part of the sensing waveguide by photolithography. The method also includes depositing an upper cladding layer on the photoresist structure, the sensing waveguide, the reference waveguide, and the lower cladding layer. The method further includes removing the photoresist structure with the part of the upper cladding layer deposited on the photoresist structure so that an opening within the upper cladding layer is formed above the sensing waveguide. The method additionally includes depositing a functionalization material within the opening. From the waveguide layer an auxiliary structure is formed by photolithography and etching the waveguide layer, and the opening is above the auxiliary structure.

The present application relates to a method for manufacturing a sensor, to a sensor and to a portable device.

### BACKGROUND OF THE INVENTION

Sensors with a waveguide can be employed for the detection of gases and liquids. For this purpose, a sensor can comprise an interferometer with two waveguides. Above one of the waveguides a covering layer is opened so that a sensor window is formed. The gases or liquids to be detected can be placed within the sensor window. The presence of the molecules to be detected can change the refractive index of the waveguide. With the interferometer a phase shift can be observed between laser light propagating in the waveguide with the sensor window and another waveguide without a sensor window. In this way, the sensor can be indicative of the presence of the molecules to be detected within the sensor window.

For fabricating the sensor it is necessary to open the layer that covers the waveguide in order to form the sensor window. The sensor window can be formed by dry etching, by wet etching or by a combination of both. Dry etching has the disadvantage that it can lead to surface damage and an increased roughness of the waveguide. An increased roughness leads to higher propagation losses, hindering the performance of the sensor. Wet etching has the disadvantage that it is an isotropic etch process and provides less control over the critical dimensions. A high etch selectivity is required which cannot be achieved with low temperature deposition processes.

In “A low-cost integrated biosensing platform based on SiN nanophotonics for biomarker detection in urine” by D. Martens et al. (Analytical Methods, 2018, 10, 3066-3073) a sensor chip comprising a Mach-Zehnder interferometer is described. A sensor window is formed by dry etching followed by wet etching.

It is an objective to provide a method for manufacturing a sensor that can be operated efficiently. It is further an objective to provide a sensor that can be operated efficiently. It is further an objective to provide a portable device that can be operated efficiently.

These objectives are achieved by the subject matter of the independent claims. Further developments and embodiments are described in dependent claims.

### SUMMARY OF THE INVENTION

According to at least one embodiment of the method for manufacturing a sensor, the method comprises the step of providing a lower cladding layer. The lower cladding layer can be arranged on a substrate. The substrate can comprise a semiconductor material, for example silicon. The lower cladding layer can be deposited on the substrate by a low temperature deposition process, as for example plasma enhanced chemical vapor deposition (PECVD) or sputtering. The lower cladding layer can comprise an oxide, for example SiO₂.

The method further comprises the step of depositing a waveguide layer on the lower cladding layer. The waveguide layer can be deposited by a low temperature deposition process, as for example PECVD or sputtering. The waveguide layer can comprise silicon nitride. The waveguide layer can completely cover the lower cladding layer.

The method further comprises the step of forming a sensing waveguide and a reference waveguide by photolithography and etching the waveguide layer in places. This can mean, that a photoresist layer is deposited on the waveguide layer. From the photoresist layer a mask is formed by photolithography. In a next step the waveguide layer is etched in the places where it is not covered by the mask. In this way, the sensing waveguide and the reference waveguide are formed. This means, the shape of the mask determines the shape of the sensing waveguide and the reference waveguide. The sensing waveguide and the reference waveguide each comprises an elongated part of the former waveguide layer. For example the sensing waveguide and the reference waveguide each have the shape of a line. The sensing waveguide and the reference waveguide can have an arbitrary shape. Between different parts of the sensing waveguide, between different parts of the reference waveguide and between the sensing waveguide and the reference waveguide air can be arranged. These spaces will be filled with a material that is different from the material of the waveguide layer in a later step. In this way, the sensing waveguide and the reference waveguide are formed and a laser pulse provided to either the sensing waveguide or to the reference waveguide can propagate through the respective waveguide. After etching the waveguide layer the mask is removed.

The method further comprises the step of forming a photoresist structure on at least a part of the sensing waveguide by photolithography. The photoresist structure can cover the sensing waveguide completely. It is further possible that the photoresist structure covers at least a part of the sensing waveguide. The photoresist structure comprises a photoresist. The reference waveguide can be free of the photoresist structure. This means, the photoresist structure is not arranged on the reference waveguide.

The method further comprises the step of depositing an upper cladding layer on the photoresist structure, the sensing waveguide, the reference waveguide and the lower cladding layer. The upper cladding layer can be deposited by a low temperature deposition process, such as sputtering. The upper cladding layer can comprise an oxide, for example SiO₂. The upper cladding layer can completely cover the photoresist structure, the sensing waveguide, the reference waveguide and the lower cladding layer. The upper cladding layer is not necessarily in direct contact with the layers that it covers.

The method further comprises the step of removing the photoresist structure with the part of the upper cladding layer deposited on the photoresist structure so that an opening within the upper cladding layer is formed above at least a part of the sensing waveguide. In the region of the opening the sensing waveguide is not covered by the upper cladding layer. The reference waveguide can be covered completely by the upper cladding layer. This means no opening in the upper cladding layer is arranged above the reference waveguide.

The method further comprises the step of depositing a functionalization material within the opening. This means, the functionalization material is deposited on the part of the sensing waveguide that is arranged within the opening. The functionalization material can be an oxide. The thickness of the functionalization material within the opening can be less than 100 nm. Preferably, the thickness of the functionalization material within the opening is less than 20 nm. The thickness is given in a vertical direction which runs perpendicular to a main plane of extension of the lower cladding layer. The functionalization material can comprise SiO₂. The functionalization material can be functionalized with molecules that change their optical properties in reaction to molecules to be detected by the sensor. For example, the functionalization material is functionalized with peptides. This means, peptides or other molecules are deposited onto the functionalization material. After the functionalization, the effective refractive index of the sensing waveguide changes when molecules to be detected are present within the opening above the sensing waveguide. The effective refractive index can be changed as the molecules to be detected form chemical bonds with the functionalized functionalization material. The functionalized functionalization material is in direct contact with the material of the sensing waveguide. In this way, a chemical change in the functionalized functionalization material due to the molecules to be detected changes the effective refractive index of the sensing waveguide.

In order to detect the molecules to be detected with the sensor the phase of a light pulse, for example a laser light pulse, provided to the sensing waveguide and the reference waveguide is compared after the passage through the two waveguides. If there are no molecules to be detected in the opening above the sensing waveguide there is no phase shift between the light pulse that passed the sensing waveguide and the light pulse that passed the reference waveguide. However, due to the change in the effective refractive index caused by the presence of molecules to be detected in the opening above the sensing waveguide, there is a phase shift between the light pulse that passed the sensing waveguide and the light pulse that passed the reference waveguide for the case that molecules to be detected are arranged in the opening above the sensing waveguide. Thus, the sensor can be a sensor for detecting molecules, in particular a smell sensor, a gas sensor or a biomolecular detector.

The method for manufacturing the sensor described herein has the advantage that the disadvantages arising from forming an opening in the upper cladding layer by etching are avoided. Thus, roughness of the sensing waveguide and the resulting propagation losses are avoided. Also the disadvantages of an isotropic wet etching process are avoided. Instead a photoresist structure is employed for the formation of the opening in the upper cladding layer. The photoresist structure can be easily removed and it does not damage the underlying and surrounding regions. Therefore, damages to the sensor are avoided and thus it can be operated more efficiently.

The method described herein furthermore has the advantage that it is compatible with low temperature deposition techniques that are employed in complementary metal-oxide semiconductor (CMOS) techniques. Thus, the method described herein is compatible with sputtering.

According to at least one embodiment of the method, the photoresist structure with the part of the upper cladding layer deposited on the photoresist structure is removed by a lift-off process. In this way, the opening in the upper cladding layer above the sensing waveguide is formed. The lift-off process has the advantage that the regions below and around the photoresist structure are not damaged.

Furthermore, it is compatible with low temperature deposition techniques that are employed in CMOS techniques. By employing the lift-off process the disadvantages of wet and dry etching are advantageously avoided.

According to at least one embodiment of the method, the functionalization material changes its chemical properties when in contact with molecules to be detected. The molecules to be detected can be gases and/or liquids. The molecules to be detected can be organic or inorganic molecules. The functionalization material can change its chemical properties due to chemical bonds between the functionalization material and the molecules to be detected. Due to this change in chemical properties the sensor can be employed to detect molecules.

According to at least one embodiment of the method, the sensing waveguide and the reference waveguide form parts of an interferometer. The sensing waveguide and the reference waveguide can form parts of a Mach-Zehnder interferometer. In the interferometer a light pulse is provided to the sensing waveguide and the reference waveguide. Both the sensing waveguide and the reference waveguide are connected with an output waveguide. In the output waveguide a phase shift between a light pulse that passed the sensing waveguide and a light pulse that passed the reference waveguide can be determined if molecules to be detected are present within the opening above the sensing waveguide. In this way, the sensor can be employed to detect molecules.

According to at least one embodiment of the method, the photoresist structure comprises a negative photoresist. In photolithography a photoresist layer is provided. In a next step a mask is arranged on the photoresist layer. Afterwards, the mask and the photoresist layer are illuminated. For a negative photoresist, the regions of the photoresist layer that were not exposed to light since they were covered by the mask are resolved. This means, during illumination the photoresist structure is not covered by a mask. After the illumination regions of the photoresist layer that were covered by the mask are removed. By employing a negative photoresist for the photoresist structure a particular shape of the photoresist structure can be achieved. How the photoresist structure can be formed is described in EP 2835687 A1 which is hereby incorporated by reference. With this photoresist structure the removal of the photoresist structure with the remaining part of the upper cladding layer is advantageously facilitated.

According to at least one embodiment of the method, the extension of the photoresist structure within planes that are parallel to the main plane of extension of the lower cladding layer decreases from a side of the photoresist structure facing away from the lower cladding layer towards a side of the photoresist structure facing the lower cladding layer. This means, the photoresist structure has a larger extension in lateral directions that run parallel to the main plane of extension of the lower cladding layer at the side where the upper cladding layer is deposited in comparison to the side where the lower cladding layer is arranged. Therefore, the upper cladding layer that is deposited around the photoresist structure does not form side walls within the opening that extend parallel to the vertical direction but that enclose an angle of less than 45 degrees with the main plane of extension of the lower cladding layer at least in places. In this setup the removal of the photoresist structure with the remaining upper cladding layer on the photoresist structure is facilitated.

According to at least one embodiment of the method, the photoresist structure is formed from a photoresist layer that is provided with a pattern formed within the photoresist layer in a border zone that surrounds the area where the photoresist structure is formed. The pattern can be a grid-like pattern. The pattern can be formed as described in EP 2835687 A1. With this, a photoresist structure having a decreasing lateral extension from the side where the upper cladding layer is deposited towards the lower cladding layer can be realized.

According to at least one embodiment of the method, the pattern comprises a dimension or structural feature that is smaller than a minimal resolution of the irradiation employed for the photolithography. The pattern can be formed as described in EP 2835687 A1.

According to at least one embodiment of the method, a metal mirror is formed within the lower cladding layer by sputtering. The metal mirror can be arranged within a region where light, in particular laser light, is provided to a waveguide that is arranged above the metal mirror. In this way, the light that is not coupled into the waveguide above the metal mirror is back reflected by the metal mirror into the waveguide. Thus, the coupling efficiency is increased.

According to at least one embodiment of the method, from the waveguide layer at least one auxiliary structure is formed by photolithography and etching the waveguide layer in places, wherein the opening is arranged above the auxiliary structure. The auxiliary structure can be formed in the same way as the sensing waveguide and the reference waveguide. However, the auxiliary structure is not in direct contact with the sensing waveguide and the reference waveguide. The auxiliary structure can have a larger extension in a lateral direction than the sensing waveguide and the reference waveguide. The auxiliary structure can be arranged within an area that is not covered by the sensing waveguide and above which the opening in the upper cladding layer is arranged. By arranging one or more auxiliary structures within the area that is not covered by the sensing waveguide and above which the opening in the upper cladding layer is arranged the probability of the formation of defects within the sensing waveguide can be reduced. This is achieved by covering at least a part of the area within the opening that is not covered by the sensing waveguide by at least one auxiliary structure. In this way, the size of the opening can be large in order to increase the area where molecules to be detected can be arranged so that the accuracy of the sensor is increased, and at the same time the probability of the formation of defects within the sensing waveguide can be reduced which would be increased for a large opening.

Furthermore, a sensor is provided. The sensor can preferably be manufactured by the method for manufacturing a sensor described herein. This means all features disclosed for the method for manufacturing a sensor are also disclosed for the sensor and vice-versa.

According to at least one embodiment of the sensor, the sensor comprises a lower cladding layer. A sensing waveguide and a reference waveguide are arranged on the lower cladding layer. An upper cladding layer is arranged on a part of the sensing waveguide, on the reference waveguide and on the lower cladding layer. The upper cladding layer does not completely cover the sensing waveguide. The upper cladding layer comprises an opening above at least a part of the sensing waveguide. The opening extends completely through the upper cladding layer. This means, the opening extends from a side of the upper cladding layer that faces away from the lower cladding layer towards the sensing waveguide.

A functionalization material is arranged within the opening. The sidewalls of the opening that are formed by the upper cladding layer enclose an angle of less than 45 degrees with a main plane of extension of the lower cladding layer at least in places. This means, parts or regions of the sidewalls of the opening that are formed by the upper cladding layer can enclose an angle of less than 45 degrees with a main plane of extension of the lower cladding layer. Thus, the opening has an extension within a plane that is parallel to the main plane of extension of the lower cladding layer, where this extension of the opening is larger at a side of the upper cladding layer facing away from the lower cladding layer than at the side of the upper cladding layer facing the lower cladding layer. The sidewalls of the opening that are formed by the upper cladding layer can enclose an angle of less than 20 degrees with a main plane of extension of the lower cladding layer.

The shape of the sidewalls of the opening is different from sensors where the opening is formed by an etching process. In sensors where the opening is formed by an etching process the sidewalls of the opening extend approximately along a vertical direction. Thus, in the sensor it is detectable that a lift-off process was employed to form the opening. The sensor described herein has the advantage that the disadvantages arising from the opening being formed by an etching process are avoided. In this way, damages to the sensor are avoided and it can be operated more efficiently.

According to at least one embodiment of the sensor, the sensor is a detector for organic or inorganic molecules. The functionalization material can be configured to change its chemical properties when organic or inorganic molecules are arranged within the opening. If the chemical properties of the functionalization material that is in direct contact with sensing waveguide change, the effective refractive index of the sensing waveguide changes as well. From this change in the effective refractive index the presence of organic or inorganic molecules can be determined.

According to at least one embodiment of the sensor, the sensing waveguide and the reference waveguide are comprised by an interferometer of the sensor. The interferometer can be a Mach-Zehnder interferometer. In this way, the sensor can be employed to detect molecules.

According to at least one embodiment of the sensor, an entrance waveguide is connected with the sensing waveguide and the reference waveguide. The entrance waveguide can be connected with a light source. The sensing waveguide and the reference waveguide can be in direct contact with the entrance waveguide so that a light pulse provided to the entrance waveguide also propagates within the sensing waveguide and the reference waveguide. In this way, the sensing waveguide and the reference waveguide can be employed in an interferometer.

According to at least one embodiment of the sensor, at the side facing away from the entrance waveguide the sensing waveguide and the reference waveguide are connected with an output waveguide. The output waveguide can be connected with a detector. The sensing waveguide and the reference waveguide can be in direct contact with the output waveguide so that light pulses propagating within the sensing waveguide and the reference waveguide reach the output waveguide. With the detector a phase shift between a light pulse that passed the sensing waveguide and a light pulse that passed the reference waveguide can be detected. From the phase shift it can be determined if molecules to be detected are arranged within the opening above the sensing waveguide. In this way, the sensor can be employed to detect molecules.

Furthermore, a portable device is provided. The portable device comprises the sensor described herein. The portable device is in particular a mobile phone, a wearable or a laptop computer.

### BRIEF DESCRIPTION OF THE DRAWINGS

The following description of figures may further illustrate and explain exemplary embodiments. Components that are functionally identical or have an identical effect are denoted by identical references. Identical or effectively identical components might be described only with respect to the figures where they occur first. Their description is not necessarily repeated in successive figures.

FIG. 1 shows an exemplary embodiment of the sensor.

With FIGS. 2A, 2B, 2C, 2D, 2E, 2F, 2G, 2H and 2I an exemplary embodiment of the method for manufacturing a sensor is described.

FIG. 3 shows another exemplary embodiment of the sensor.

FIG. 4 shows a detail of an exemplary embodiment of the sensor.

With FIGS. 5A, 5B and 5C steps of another exemplary embodiment of the method for manufacturing a sensor are described.

With FIGS. 6A and 6B another exemplary embodiment of the sensor and of the method for manufacturing a sensor are described.

FIG. 7 shows an exemplary embodiment of a portable device.

### DETAILED DESCRIPTION

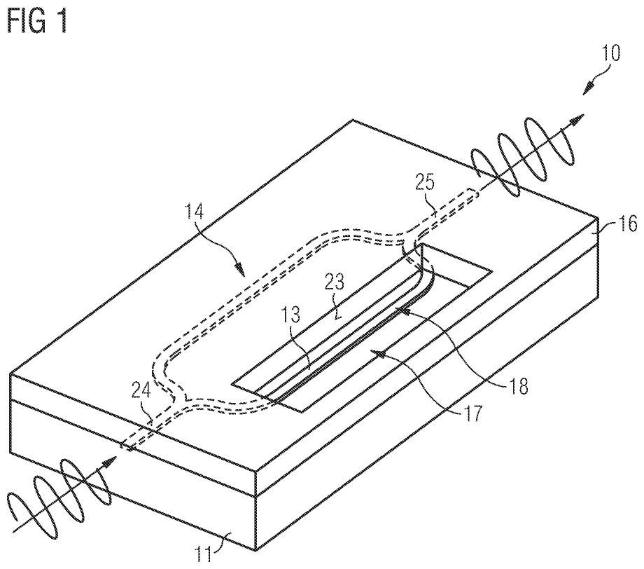

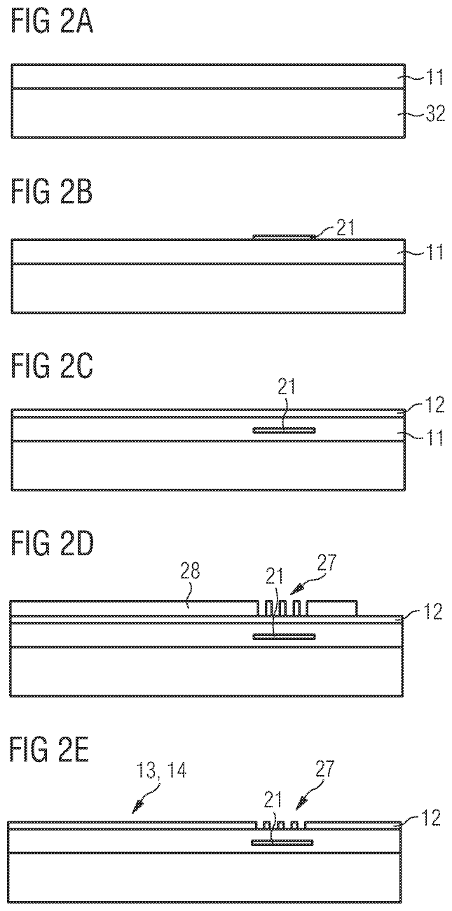

FIG. 1 shows an exemplary embodiment of a sensor 10. The sensor 10 comprises a lower cladding layer 11. The sensor 10 further comprises a sensing waveguide 13 and a reference waveguide 14 that are both arranged on the lower cladding layer 11. An upper cladding layer 16 is arranged on a part of the sensing waveguide 13, on the reference waveguide 14 and on the lower cladding layer 11. The upper cladding layer 16 completely covers the reference waveguide 14. The upper cladding layer 16 comprises an opening 17 above at least a part of the sensing waveguide 13. This means, the upper cladding layer 16 is removed above a part of the sensing waveguide 13. Within the opening 17 the sensing waveguide 13 is free of the upper cladding layer 16. A functionalization material 18 is arranged within the opening 17. The functionalization material 18 is arranged on the sensing waveguide 13 within the opening 17. This means, the sensing waveguide 13 is covered by the functionalization material 18 within the opening 17. The sidewalls 23 of the opening 17 that are formed by the upper cladding layer 16 enclose an angle of less than 45 degrees with a main plane of extension of the lower cladding layer 11 at least in places. The sidewalls 23 of the opening 17 are shown in FIG. 2H.

The sensor 10 can be a detector for organic or inorganic molecules. Organic or inorganic molecules can be detected as follows. An entrance waveguide 24 is connected with the sensing waveguide 13 and the reference waveguide 14. A light pulse, in particular a laser light pulse, is provided to the entrance waveguide 24. At the position where the entrance waveguide 24 is connected with the sensing waveguide 13 and the reference waveguide 14 the light pulse is split and it propagates in the sensing waveguide 13 and the reference waveguide 14. The light propagates within the waveguides due to total internal reflection. At the side facing away from the entrance waveguide 24 the sensing waveguide 13 and the reference waveguide 14 are connected with an output waveguide 25. This means a light pulse that passed the sensing waveguide 13 reaches the output waveguide 25 and a light pulse that passed the reference waveguide 14 reaches the output waveguide 25 as well. In case that molecules to be detected are arranged on the sensing waveguide 13 within the opening 17 chemical bonds are formed between the molecules to be detected and the functionalization material 18. Consequently, the chemical properties of the functionalization material 18 are changed. This results in a change in the effective refractive index of the sensing waveguide 13. In the output waveguide 25 a phase shift can be detected between a light pulse that passed the sensing waveguide 13 on which molecules to be detected are arranged within the opening 17 and a light pulse that passed the reference waveguide 14. As the reference waveguide 14 is completely covered by the upper cladding layer 16 the effective refractive index of the reference waveguide 14 does not change. From the phase shift detected in the output waveguide 25 the presence of molecules to be detected can be determined. Thus, the sensor 10 can be a sensor 10 for detecting organic or inorganic molecules.

In order to detect a phase shift between light pulses that passed the sensing waveguide 13 and light pulses that passed the reference waveguide 14, the sensing waveguide 13 and the reference waveguide 14 can be comprised by an interferometer of the sensor 10. The set up shown in FIG. 1 shows an interferometer that comprises the sensing waveguide 13 and the reference waveguide 14. In order to detect the phase shift between light pulses in the output waveguide 25 a detector can be connected to the output waveguide 25.

With FIGS. 2A to 2I an exemplary embodiment of the method for manufacturing a sensor 10 is described. In FIGS. 2A to 2I side views are shown.

FIG. 2A shows that a lower cladding layer 11 is provided. The lower cladding layer 11 is arranged on a substrate 32. The lower cladding layer 11 can be deposited on the substrate 32 by PECVD or sputtering. The lower cladding layer 11 completely covers the substrate 32.

FIG. 2B shows that a metal mirror 21 is formed on the lower cladding layer 11. A metal layer is deposited on the lower cladding layer 11 by sputtering. Subsequently the metal layer is structured so that the metal mirror 21 is formed. This means, parts of the metal layer are removed so that the metal mirror 21 remains. The metal mirror 21 only covers a part of the lower cladding layer 11.

FIG. 2C shows that the lower cladding layer 11 and the metal mirror 21 are covered by a further part of the lower cladding layer 11. This means, the metal mirror 21 is arranged within the lower cladding layer 11. The metal mirror 21 is completely covered by the lower cladding layer 11. A waveguide layer 12 is deposited on the lower cladding layer 11. The waveguide layer 12 completely covers the lower cladding layer 11.

FIG. 2D shows that a mask 28 is formed on the waveguide layer 12. The mask 28 does not cover the areas of the waveguide layer 12 that are to be removed in order to form a sensing waveguide 13 and a reference waveguide 14. This means, the mask 28 does not completely cover the waveguide layer 12. In the region of the metal mirror 21 an input 27 for providing light pulses to the sensing waveguide 13 and the reference waveguide 14 will be formed. Thus, the mask 28 is structured in the region of the metal mirror 21.

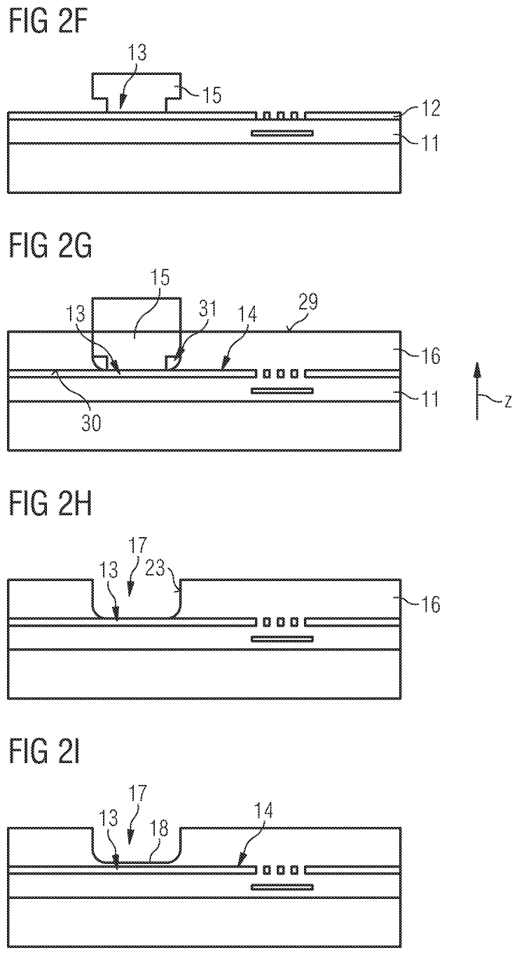

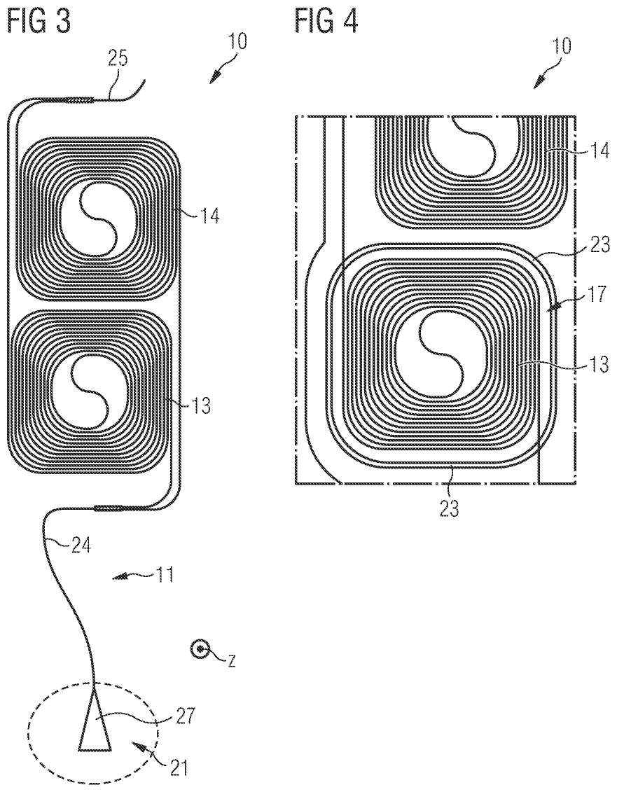

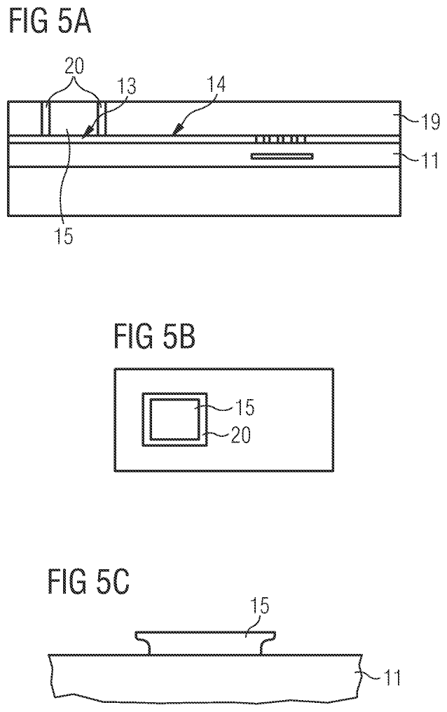

In the step of the method shown in FIG. 2E the sensing waveguide 13 and the reference waveguide 14 are formed by photolithography and etching the waveguide layer 12 in places. This means, the waveguide layer 12 is removed by etching in the areas that are not covered by the mask 28. In the side view shown in FIG. 2E the sensing waveguide 13 and the reference waveguide 14 are not visible. The shape of the sensing waveguide 13 and the reference waveguide 14 are shown in a top view in FIGS. 3 and 4. Above the metal mirror 21 the input 27 is formed. In the region of the input 27 the waveguide layer 12 is structured. After forming the sensing waveguide 13 and the reference waveguide 14 the mask 28 is removed.

FIG. 2F shows that a photoresist structure 15 is formed on at least a part of the sensing waveguide 13 by photolithography. The photoresist structure 15 comprises a negative photoresist. The photoresist structure 15 is formed from a photoresist layer 19 by photolithography. The photoresist structure 15 does not completely cover the remaining waveguide layer 12 and the lower cladding layer 11. The photoresist structure 15 is only arranged above a part of the sensing waveguide 13 and a region surrounding the sensing waveguide 13. The extension of the photoresist structure 15 within planes that are parallel to the main plane of extension of the lower cladding layer 11 decreases from a side of the photoresist structure 15 facing away from the lower cladding layer 11 towards a side of the photoresist structure 15 facing the lower cladding layer 11.

FIG. 2G shows that an upper cladding layer 16 is deposited on the photoresist structure 15, the sensing waveguide 13, the reference waveguide 14 and the lower cladding layer 11. The upper cladding layer 16 can comprise the same material as the lower cladding layer 11. The upper cladding layer 16 can be formed in the same way as the lower cladding layer 11. The upper cladding layer 16 completely covers the underlying structures. Due to the shape of the photoresist structure 15 described with FIG. 2F the upper cladding layer 16 forms a slope around the photoresist structure 15. The photoresist structure 15 has an overhanging shape so that it has a larger extension at a top side 29 of the upper cladding layer 16 facing away from the lower cladding layer 11 in comparison to a bottom side 30 of the upper cladding layer 16 facing the lower cladding layer 11. This results in material of the upper cladding layer 16 being deposited below the overhanging shape of the photoresist structure 15. This means, at the bottom side 30 of the upper cladding layer 16 the thickness of the upper cladding layer 16 in a vertical direction z increases with the distance from the photoresist structure 15. The vertical direction z extends perpendicular to the main plane of extension of the lower cladding layer 11. In this way, a slope of the upper cladding layer 16 around the photoresist structure 15 is formed. In the region around the photoresist structure 15 the edge of the upper cladding layer 16 encloses an angle of less than 45 degrees with the main plane of extension of the lower cladding layer 11. Below the overhanging shape of the photoresist structure 15 a gap 31 remains where no material of the upper cladding layer 16 is arranged.

FIG. 2H shows that the photoresist structure 15 with the part of the upper cladding layer 16 deposited on the photoresist structure 15 is removed so that an opening 17 within the upper cladding layer 16 is formed above at least a part of the sensing waveguide 13. The photoresist structure 15 with the part of the upper cladding layer 16 deposited on the photoresist structure 15 is removed by a lift-off process. The opening 17 extends completely through the upper cladding layer 16. The sidewalls 23 of the opening 17 that are formed by the upper cladding layer 16 enclose an angle of less than 45 degrees with a main plane of extension of the lower cladding layer 11 in places.

FIG. 2I shows that a functionalization material 18 is deposited within the opening 17. The functionalization material 18 is deposited on the sensing waveguide 13. The functionalization material 18 can be functionalized with molecules, for example peptides. The functionalization material 18 changes its chemical properties when in contact with molecules to be detected. In order to detect molecules within the opening 17 the sensing waveguide 13 and the reference waveguide 14 can form parts of an interferometer.

FIG. 3 shows a top view on another exemplary embodiment of the sensor 10. The sensing waveguide 13 and the reference waveguide 14 each have approximately the shape of a coil. The sensing waveguide 13 and the reference waveguide 14 are arranged adjacent to each other on the lower cladding layer 11. The sensing waveguide 13 and the reference waveguide 14 are connected to the entrance waveguide 24. At the side facing away from the entrance waveguide 24 the sensing waveguide 13 and the reference waveguide 14 are connected with an output waveguide 25. At the side facing away from the sensing waveguide 13 and the reference waveguide 14 the entrance waveguide 24 is connected to the input 27. At the input 27 light pulses can be provided to the entrance waveguide 24. The metal mirror 21 is arranged below the input 27 in the vertical direction z.

FIG. 4 shows a detail of the exemplary embodiment of the sensor 10 shown in FIG. 3. The opening 17 is arranged above the sensing waveguide 13. In FIG. 4 the sidewalls 23 of the opening 17 are shown. The sidewalls 23 of the opening 17 extend approximately square-shaped around the sensing waveguide 13. Above the reference waveguide 14 no opening 17 is arranged.

With FIGS. 5A, 5B and 5C steps of another exemplary embodiment of the method for manufacturing a sensor 10 are described.

FIG. 5A shows a step of the method for manufacturing the sensor 10 that takes place between the steps shown in FIGS. 2E and 2F. For forming the photoresist structure 15 a photoresist layer 19 is deposited on the sensing waveguide 13, the reference waveguide 14 and the lower cladding layer 11. The photoresist layer 19 is provided with a pattern 20 formed within the photoresist layer 19 in a border zone that surrounds the area where the photoresist structure 15 is formed. In FIG. 5A a side view is shown. In a top view the pattern 20 can have the shape of a square or a rectangle. Thus, in the side view in FIG. 5A two parts of the pattern 20 are visible. The pattern 20 comprises a dimension or structural feature that is smaller than a minimal resolution of the irradiation employed for the photolithography. The photoresist structure 15 is formed from this photoresist layer 19.

FIG. 5B shows a top view on the step of the method shown in FIG. 5A. The pattern 20 has the shape of a rectangle and surrounds the area where the photoresist structure 15 is formed.

FIG. 5C shows a side view of the photoresist structure 15 arranged on the lower cladding layer 11. The photoresist structure 15 has an overhanging shape. This means, the extension of the photoresist structure 15 within planes that are parallel to the main plane of extension of the lower cladding layer 11 decreases from a side of the photoresist structure 15 facing away from the lower cladding layer 11 towards a side of the photoresist structure 15 facing the lower cladding layer 11. This photoresist structure 15 can be formed by the steps of the method described with FIGS. 5A and 2F.

With FIGS. 6A and 6B another exemplary embodiment of the sensor 10 and of the method for manufacturing the sensor 10 are described.

FIG. 6A shows a top view on a part of another exemplary embodiment of the sensor 10. In the top view the sensing waveguide 13 is shown. Two auxiliary structures 22 are arranged within the opening 17 in the center of the sensing waveguide 13. The auxiliary structures 22 are arranged on areas within the opening 17 that are not covered by the sensing waveguide 13. The shape of the auxiliary structures 22 is adapted to these areas within the opening 17 that are not covered by the sensing waveguide 13. Thus, the two auxiliary structures 22 each have an elongated oval shape. However, the auxiliary structures 22 can have any shape. The auxiliary structures 22 are formed from the waveguide layer 12 by photolithography and etching the waveguide layer 12 in places.

FIG. 6B shows another top view on the exemplary embodiment of the part of the sensor 10 shown in FIG. 6A. The sensing waveguide 13 with the opening 17 is shown. In the center of the sensing waveguide 13 within the opening 17 two the auxiliary structures 22 are arranged. Furthermore, a part of the reference waveguide 14 is shown. In the center of the reference waveguide 14 no auxiliary structures 22 are arranged.

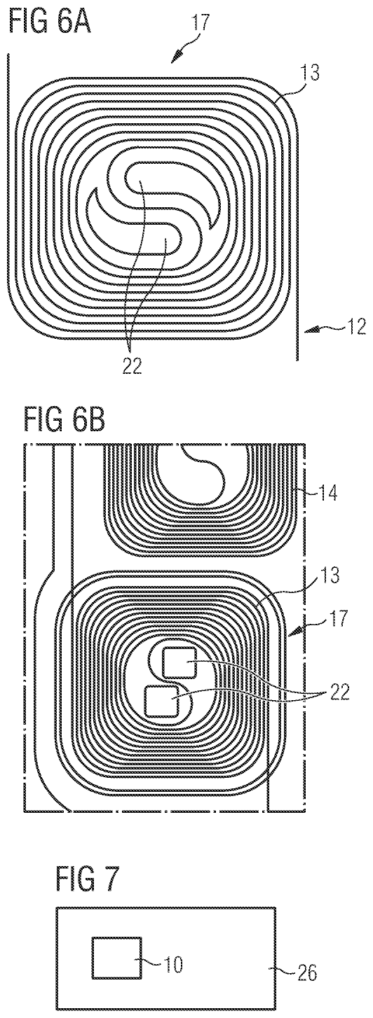

FIG. 7 shows an exemplary embodiment of a portable device 26. The portable device 26 comprises the sensor 10. In particular, the portable device 26 is a mobile phone, a wearable or a laptop computer.

It will be appreciated that the disclosure is not limited to the disclosed embodiments and to what has been particularly shown and described hereinabove. Rather, features recited in separate dependent claims or in the description may advantageously be combined. Furthermore, the scope of the disclosure includes those variations and modifications, which will be apparent to those skilled in the art. The term “comprising”, insofar it was used in the claims or in the description, does not exclude other elements or steps of a corresponding feature or procedure. In case that the terms “a” or “an” were used in conjunction with features, they do not exclude a plurality of such features. Moreover, any reference signs in the claims should not be construed as limiting the scope.

This patent application claims priority from German patent application 10 2021 112 276.7, the disclosure content of which is hereby included by reference.

### REFERENCE NUMERALS

10 sensor
11 lower cladding layer
12 waveguide layer
13 sensing waveguide
14 reference waveguide
15 photoresist structure
16 upper cladding layer
17 opening
18 functionalization material
19 photoresist layer
20 pattern
21 metal mirror
22 auxiliary structure
23 sidewalls
24 entrance waveguide
25 output waveguide
26 portable device
27 input
28 mask
29 top side
30 bottom side
31 gap
32 substrate
z vertical direction

1. A method for manufacturing a sensor, the method comprising the steps:
providing a lower cladding layer,
depositing a waveguide layer on the lower cladding layer,
forming a sensing waveguide and a reference waveguide by photolithography and etching the waveguide layer in places,
forming a photoresist structure on at least a part of the sensing waveguide by photolithography,
depositing an upper cladding layer on the photoresist structure, the sensing waveguide, the reference waveguide and the lower cladding layer,
removing the photoresist structure with the part of the upper cladding layer deposited on the photoresist structure so that an opening within the upper cladding layer is formed above at least a part of the sensing waveguide, and
depositing a functionalization material within the opening, wherein
from the waveguide layer at least one auxiliary structure is formed by photolithography and etching the waveguide layer in places, wherein the opening is arranged above the auxiliary structure.

2. The method for manufacturing a sensor according to claim 1, wherein the photoresist structure with the part of the upper cladding layer deposited on the photoresist structure is removed by a lift-off process.

3. The method for manufacturing a sensor according to claim 1, wherein the functionalization material changes its chemical properties when in contact with molecules to be detected.

4. The method for manufacturing a sensor according to claim 1, wherein the sensing waveguide and the reference waveguide form parts of an interferometer.

5. The method for manufacturing a sensor according to claim 1, wherein the photoresist structure comprises a negative photoresist.

6. The method for manufacturing a sensor according to claim 1, wherein the extension of the photoresist structure within planes that are parallel to the main plane of extension of the lower cladding layer decreases from a side of the photoresist structure facing away from the lower cladding layer towards a side of the photoresist structure facing the lower cladding layer.

7. The method for manufacturing a sensor according to claim 1, wherein the photoresist structure is formed from a photoresist layer that is provided with a pattern formed within the photoresist layer in a border zone that surrounds the area where the photoresist structure is formed.

8. The method for manufacturing a sensor according to claim 1, wherein the pattern comprises a dimension or structural feature that is smaller than a minimal resolution of the irradiation employed for the photolithography.

9. The method for manufacturing a sensor according to claim 1, wherein a metal mirror is formed within the lower cladding layer by sputtering.

10. The method for manufacturing a sensor according to claim 1, wherein the sensing waveguide and the reference waveguide each have the shape of a coil.

11. A sensor comprising:
a lower cladding layer,
a sensing waveguide and a reference waveguide arranged on the lower cladding layer, and
an upper cladding layer arranged on a part of the sensing waveguide, on the reference waveguide and on the lower cladding layer, wherein
the upper cladding layer comprises an opening above at least a part of the sensing waveguide,
a functionalization material is arranged within the opening, and
the sidewalls of the opening that are formed by the upper cladding layer enclose an angle of less than 45 degrees with a main plane of extension of the lower cladding layer at least in places.

12. The sensor according to claim 11, wherein the sensor is a detector for organic or inorganic molecules.

13. The sensor according to claim 11, wherein the sensing waveguide and the reference waveguide are comprised by an interferometer of the sensor.

14. The sensor according to claim 11, wherein an entrance waveguide is connected with the sensing waveguide and the reference waveguide.

15. The sensor according to claim 11, wherein at the side facing away from the entrance waveguide the sensing waveguide and the reference waveguide are connected with an output waveguide.

16. A portable device comprising the sensor according to claim 11, wherein the portable device is in particular a mobile phone, a wearable or a laptop computer.
